(19) United States
(12) Patent Application Publication
(10) Pub. No.: US 2023/0095291 A1
(43) Pub. Date: Mar. 30, 2023

(54) A POLYMER ADDITIVE POWDER COMPOSITION

(71) Applicants: Prakash KAMAT, Mumbai (IN); Narendra AYARE, Mumbai (IN); FINE ORGANIC INDUSTRIES LIMITED, Mumbai (IN)

(72) Inventors: Prakash KAMAT, Mumbai (IN); Narendra AYARE, Mumbai (IN)

(21) Appl. No.: 17/797,649

(22) PCT Filed: Feb. 4, 2021
(86) PCT No.: PCT/IN2021/050114

§ 371 Date: Aug. 4, 2022

(30) Foreign Application Priority Data
Feb. 4, 2020 (IN) 202021004788

(51) Int. Cl. C08J 3/22; C08K 9/10; C08K 3/36; C08K 5/20

(52) U.S. Cl. CPC C08J 3/223; C08K 3/36; C08K 5/20; C08K 9/10; C08J 2323/06; C08K 2201/005

(57) ABSTRACT

A polymer additive powder composition comprising (a) slip agent(s); (b) antiblock agent(s); and (c) optionally one or more components; wherein the slip to antiblock agent(s) is in the range of 80:20 to 95:5 parts by weight and wherein the slip agent encapsulates the antiblock agent(s).

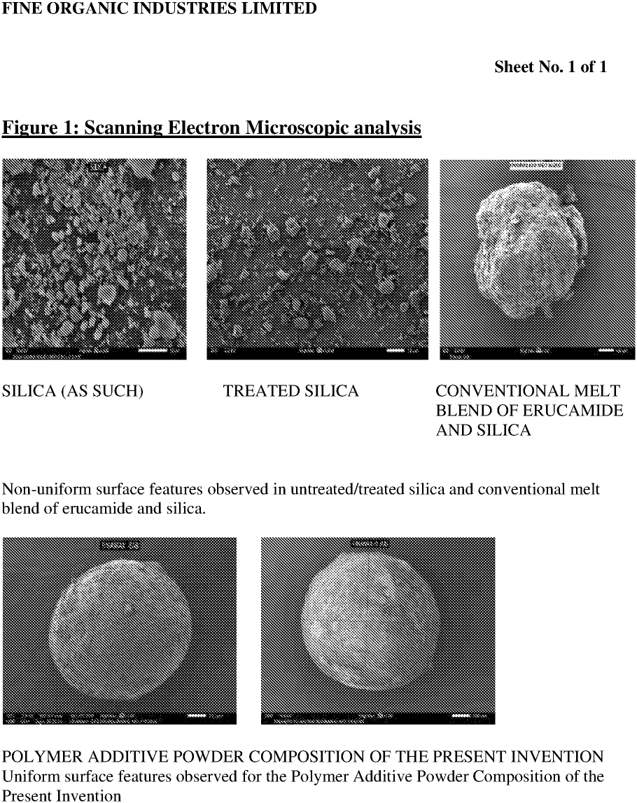

The present invention is related to a novel polymer additive powder composition, its process of preparation and its use in manufacturing polymer films. The polymer additive of the present invention is a free flowing powdercomposition of 300 to 500 microns particle size (d50) which displays slip and antiblock properties when added to polymer resin during manufacture of polymer films.

### BACKGROUND OF THE INVENTION

U.S. Pat. No. US3266924 (assigned to M/S National Distillers and Chemical Corporation) discloses a method for producing additive mixtures that bestow good slip and antiblocking properties to polyethylene film, such mixtures having the form of a free-flowing, non-dusting, uniform, easily handled powder. However, the additive mixture has slip to antiblock agent in the ratio1:3 to 2:1 which on mixing with polyethylene resins does not disperse uniformly resulting in non-uniform, hazy films. The polymer additive of the present invention has slip to antiblock agent weight ratio in the range of 80:20 to 95:5 (4:1 to 19:1) which can be used to manufacture uniform polymer films.

U.S. Pat. No. US4675122 (assigned to M/S GraceGmBH) describes the preparation of mixtures of silica gel and slip agents in 1:1 weight ratio. The polymer additive of the present invention has slip to antiblock agent weight ratio in the range of 80:20 to 95:5 (4:1 to 19:1) and provides desirable antiblock properties with very low amounts of antiblock agents.

PCT publication number WO9941308 (applicant M/S GraceGmBH) discloses an integrated additive composition which contains anti-block agent and at least one organic component wherein the organic component is localized in the pores of the antiblock agent. The organic component to anti-block agent is 3:7 parts by weight. The polymer additive of the present invention has slip to antiblock agent weight ratio in the range of 80:20 to 95:5 (4:1 to 19:1) and provides desirable antiblock properties with very low amounts of antiblock agents.

### OBJECT OF THE INVENTION

The object of the present invention is to provide a novel polymer additive powdercomposition which can be added to polymer resin during manufacture into an uniform, transparent film with improved film quality, lower Coefficient of Friction and blocking force. Further, the polymer additive is a free flowing powder composition.

A second object of the present invention is to provide a novel process for the preparation of the polymer additive powder composition.

### SUMMARY OF THE INVENTION

A polymer additive powdercomposition comprising
(a) slip agent(s);
(b) antiblock agent(s); and
(c) optionally one or more components;
wherein the slip to antiblock agent(s) is in the range of 80:20 to 95:5 parts by weight and wherein the slip agent encapsulates the antiblock agent(s).

A process for the preparation of polymer additive composition comprising melting slip agent(s), adding antiblock agent, encapsulating and powdering to obtain a free flowing powder using a spray tower.

### DEFINITION OF TERMS

### Coefficient of Friction ASTM D1894

Coefficient of friction is the ratio of the force required to move one surface over another to the total force applied normal to those surfaces.

Kinetic coefficient of friction is the ratio of the force required to move one surface over another to the total force applied normal to those surfaces, once that motion is in progress.

Static coefficient of friction is the ratio of the force required to move one surface over another to the total force applied normal to those surfaces, at the instant motion starts.

### Blocking Force ASTM D 3354

Blocking phenomenon is defined as the undesired adhesion of the smooth film surfaces, when in direct contact, typically under the influence of elevated temperature and/or pressure. The blocking force is the perpendicular load determined in grams that is required in order to separate the film surfaces adhered to each other due to ‘blocking’.

### % Haze Value ASTM D 1003

Haze is a physical process of light scattering by the surface imperfections or by in homogeneities while passing through the film or a sheet, which causes ‘milky’ appearance. Therefore, typically the film clarity is significantly deteriorated as the haze values increase.

### Fisheyes and Gels ASTM D 7310

‘Fish-eyes’ are one of the surface defects observed in the plastic films, due to inadequate mixing and/or presence of inorganic components. Further, the ‘gels’ occur due to the polymeric material, which exhibits incomplete fusion. The standard provides a guideline to visually rate the film quality based on the size and number of surface defects present.

### DESCRIPTION OF THE INVENTION

The polymer film manufacturing process essentially requires two additives a) anti-blocking agents and b) slip agents among other components. These two additives are typically used in concentrations of 1000 to 3000 ppm in polymer films. The two additives may be used as separate powders or pre-mixed compositions. Conventional integrated blends have significantly high % of silica as antiblock agent for e.g Sylobloc 243H has 43% silica and 57% erucamide, Sylobloc 250/250H 50% silica and 50% erucamide.

According to the first embodiment of the present invention is a polymer additive powdercomposition comprising
(a) slip agent(s);
(b) antiblock agent(s); and
(c) optionally one or more components;
wherein the slip to antiblock agent(s) is in the range of 80:20 to 95:5 parts by weight and wherein the slip agent encapsulates the antiblock agent(s).

Preferably, the polymer additive powder composition of the present invention is a free flowing powder.

The polymer additive powdercomposition of the present invention has d50 particle size of 300 to 500 microns as measured by Laser diffraction analyzer such as Malvern Particle size analyzer.

The slip agent(s) may be selected from primary and secondary fatty amides such as oleamide, erucamide, gadoleamide,isostearamide, bisoleamide,biserucamide, stearylerucamide, oleylpalmitamide, oleyloleamide and the like.

The antiblock agent may be selected form inorganic compounds selected from silica, alumina, talc, limestone, clay, celite, titanium dioxide, calcium hydrogen phosphate, calcium carbonate, synthetic zeolites and the like.

The components may be selected form antioxidants, antistatic agents, stabilizers, flame retardants, metal soaps, nucleating agents and the like.

The antioxidants may be selected from sterically hindered phenols, secondary aryl amines, phosphorous compositions, thioesters, hydroxylamines and the like.

The antistatic agents may be selected from ammonium salts, glycerin esters, anionic compounds and the like.

The flame retardants may be selected from halogenated organic compounds, metal hydrates and mixtures thereof.

The polymer additive powder composition of the present invention is stable, free flowing and displays no sign of separation of the components even after prolonged pneumatic conveyance and different modes of transportation.

The polymer additive powder composition of the present invention is used at 0.05 to 0.5% by weight of the polymer for manufacturing polymeric films.

The polymer may be selected from LDPE, LLDPE, PP and EVA.

The polymer additive powder composition of the present invention when added to polymer resin is processed into an uniform, transparent film with improved film quality such as optical properties and deposition on equipments when measured by ASTM D-7310 and 1003 as compared to treated or untreated silica or other antiblocks.

The polymer additive powder composition of the present invention when added to polymer resin is processed into an uniform, transparent film with dynamic and static coefficient of frictionless than 0.3 when measured by ASTM D 1894.

Particularly, the polymer additive powder composition of the present invention when added to polymer resin is processed into an uniform, transparent film with dynamic and static coefficient of frictionless than 0.3 and coefficient of friction is 3 to 5 times lower than treated or untreated silica or other antiblocks when measured by ASTM D 1894.

The polymer additive powder composition of the present invention when added to polymer resin is processed into an uniform, transparent film with blocking force of less than 5 gm when measured with 5 kg load @50° C. by ASTM D-3354.

Particularly, the polymer additive powder composition of the present invention when added to polymer resin is processed into an uniform, transparent film with blocking force of less than 5 gm and the blocking force is 4 to 5 times lower than treated or untreated silica or other antiblocks when measured with 5 kg load @50° C. by ASTM D-3354.

According to the second embodiment of the present invention is a process for the preparation of polymer additive powder composition comprising melting the slip agent(s), adding antiblock agent, encapsulating and powdering to obtain a free flowing powder using a spray tower. Preferably, a process for the preparation of polymer additive powder composition comprising melting the slip agent(s) at 10 to 20° C. above the melting point of the slip agent(s), adding antiblock agent, encapsulating and powdering to obtain a free flowing powder using a spray tower.

Encapsulation facilitates use of minimum amount of inorganic antiblock agents together with slip agents and provides desired antiblock and slip properties with elimination or reduction of the disadvantages arising out of higher amounts of inorganic antiblock agents such as surface roughness of the film.

The free flowing powder with d50 particle size of300 to 500 microns as measured by Laser diffraction analyzer such as Malvern Particle size analyzer.

The polymer additive powder composition of the present invention may be added to polymer resin prior to processing into polymer films such as LDPE, LLDPE, PP and EVA films. The polymer additive disperses uniformly in the polymer mixture enabling uniform, transparent polymer films.

The polymer films may be manufactured by blown, cast and BOPP process for polyolefinic materials such as PP, LDPE, LLDPE and EVA.

The polymer additive of the present invention provides several advantages in processing of the polymeric film, end use of the film during packaging and physical appearance of the polymeric film in view of improved properties like lower coefficient of friction, lower blocking force and less number of fisheyes and gels.

The polymeradditive of the present invention provides increased process efficiency as the additive comprises both slip agent and antiblock agent so no separate addition required, increased output as faster line speed, no die lip buildup as the coefficient of friction between film and collapsing board is lower. Additionally, supports smoother processing without defects rendering films totally free of hard particles, fisheyes, gels and lower pinholes arising from the hard particles.

At the processing end the polymer additive of the present invention provides smoother film winding as the blocking between two film surfaces is reduced.

At the film user end film rolls can be easily unwound post long term storage due to lower blocking, enabling higher efficiency of packaging.

The film has better aesthetic look in view of lower haze values leading to improved transparency and gloss.

### EXAMPLES

### Example 1: Preparation of the Polymer Additive Composition

Melt 80-95 gm erucamide at 100deg C and 20-5 gm of silica is added. The mixture is encapsulated and powdered using spray tower.

### Example 2: Comparison of a Slip/Antiblock Study in LDPE Films

| Test Parameters | Control | Polymer additive powder composition of the invention | Silica treated (Sylobloc 45H) | Silica | | | |
|---|---|---|---|---|---|---|---|
| | LDPE (3MFI) | 1000 ppm | 2500 ppm | 1000 ppm | 2500 ppm | 1000 ppm | 2500 ppm |
| COF-Ref-ASTM D-1894 | | | | | | | |
| Average Dynamic COF | 0.85 | 0.11 | 0.10 | 0.49 | 0.43 | 0.52 | 0.46 |
| Average Static COF | 0.87 | 0.13 | 0.12 | 0.49 | 0.47 | 0.56 | 0.49 |

| | | | | | | | |
|---|---|---|---|---|---|---|---|
| Blocking force (gms)-Ref-ASTM D-3354 | | | | | | | |
| Blocking Force (gms) *with 5 kg load @50 deg C | 48 | 2 | Nil | 25 | 16 | 22 | 12 |

| | | | | | | | |
|---|---|---|---|---|---|---|---|
| Fish eyes and Gels Ref-ASTM-D-7310 | | | | | | | |
| Size of fisheyes and Gels | <0.4 mm-3-6 | <0.4 mm-4-6 | <0.4 mm-5-7 | <0.4 mm -5-8 | <0.4 mm-6-8 | <0.4 mm -5-9 | <0.4 m m-6-10 |

Haze Values Test Method ASTM D 1003

| | | | | | | | |
|---|---|---|---|---|---|---|---|
| Haze Values% | 13 | 13.5 | - | 15.5 | - | 15 | - |

### Example 3: Comparison of a Slip/Antiblock Study in LLDPE (octene Grade) Films

| | Control | Polymer additive powder composition of the invention | Silica treated (Sylobloc 45H) | Silica | | | |
|---|---|---|---|---|---|---|---|
| | LLDPE (2MFI) | 1000 ppm | 2500 ppm | 1000 ppm | 2500 ppm | 1000 ppm | 2500 ppm |
| COF-Ref-ASTM D-1894 | | | | | | | |
| Average Dynamic COF | 0.72 | 0.11 | 0.10 | 0.50 | 0.47 | 0.46 | 0.41 |
| Average Static COF | 0.73 | 0.14 | 0.11 | 0.55 | 0.49 | 0.5 | 0.48 |

| Blocking force (gms)-Ref-ASTM D-3354 | | | | | | | |
|---|---|---|---|---|---|---|---|
| Blocking Force (gms) *with 5 kg load @50 deg C | 68 | 5 | Nil | 35 | 19 | 28 | 17 |
| Fish eyes and Gels Ref-ASTM-D-7310 | | | | | | | |
| Size of fisheyes and Gels | <0.4 mm-2-4 | <0.4 mm-2-5 | <0.4 mm-2-5 | <0.4mm -2-4 | <0.4 mm-3-5 | <0.4mm -3-4 | <0.4 m m-3-6 |
| Haze Values Test Method ASTM D 1003 | | | | | | | |
| Haze Values% | 20 | 30 | - | 30 | - | 34 | - |

### Example 4 :Comparison of a Slip/Antiblock Study in PP Films

| | Control | Polymer additive powder composition of the invention | Silica treated (Sylobloc 45H) | Silica | | | |
|---|---|---|---|---|---|---|---|
| | PP(3MFI) Homopolymer | 1000 ppm | 2500 ppm | 1000 ppm | 2500 ppm | 1000 ppm | 2500 ppm |
| COF-Ref-ASTM D-1894 | | | | | | | |
| Average Dynamic COF | 0.57 | 0.27 | 0.17 | 0.42 | 0.34 | 0.45 | 0.43 |
| Average Static COF | 0.59 | 0.27 | 0.19 | 0.45 | 0.38 | 0.49 | 0.46 |
| Blocking force (gms)-Ref-ASTM D-3354 | | | | | | | |
| Blocking Force (gms) *with 5 kg load @50 deg C | 4 | Nil | Nil | Nil | Nil | Nil | Nil |
| Fish eyes and Gels Ref-ASTM-D-7310 | | | | | | | |
| Size of fisheyes and Gels | <0.4 mm-3-5 | <0.4 mm -4-6 | <0.4 mm-5-7 | <0.4 mm -4-6 | <0.4 mm-6-8 | <0.4 mm -5-7 | <0.4 mm -6-9 |

### Example 5: FinaSlip EAB

### Set I) Findings from Additional Studies

Our additional studies have been carried out with the base polymer of LLDPE (butene copolymer grade) and a typical formulation with silica and erucamide has been included in the evaluation for comparison purpose.

| | LLDPE (butene grade MFI: 0.9) | Silica + Erucamide (Recipe for comparison) | FinaSlip EAB (ppm) | |
|---|---|---|---|---|
| Sample description | Control | (2000+1000) ppm | 2000 | 3000 |
| Blocking Force Induced, gms | 132.5 | 16 | 41.7 | 18.3 |
| Kinetic CoF | 1.03 | 0.141 | 0.128 | 0.113 |

### Observations

FinaSlip EAB can offer effective antiblocking and better slip performance at 2000 ppm compared to the typical recipe.FinaSlip EAB can offer comparable antiblocking and superior slip performance at 3000 ppm compared to the typical recipe.

### Set II) Additional Data of FinaSlip EAB - Superior Film Quality/Visual Appearance Haze Values Determination)

| | Control | Silica + Erucamide (Recipe for comparison) (2500+1000) ppm | FinaSlip EAB (ppm) | | |
|---|---|---|---|---|---|
| | | | 900 | 1500 | 2000 |
| CoF | 0.877 | 0.114 | 0.286 | 0.152 | 0.119 |
| Blocking force (gm) [Induced] | 141 | 26 | 77 | 57 | 58 |
| Transmittance (%) | 85.5 | 82.2 | 85.4 | 85 | 86.1 |
| Gloss at 60° | 90 | 70 | 97 | 96 | 98 |
| Haze (%) | 18.3 | 22 | 15.5 | 14.8 | 15.1 |

### Observations

FinaSlip EAB can offer effective antiblocking and better slip performance at 2000 ppm compared to the typical recipe. FinaSlip EAB can offer significantly superior film quality, which is reflected in the lower haze values noted in the specimens with FinaSlip EAB compared to the specimens prepared with typical recipe.

We claim:

1. A polymer additive powder composition comprising
(a) slip agent(s);
(b) antiblock agent(s); and
(c) optionally one or more components;
wherein the slip to antiblock agent(s) is in the range of 80:20 to 95:5 parts by weight and
wherein the slip agent encapsulates the antiblock agent(s).

2. A polymer additive powder composition as claimed in claim 1 is a free flowing powder composition.

3. A polymer additive composition as claimed in claim 1 with d50 particle size of 300 to 500 microns as measured by Malvern particle size analyzer.

4. A polymer additive composition as claimed in claim 1 wherein the slip agent(s) is selected from primary and secondary fatty amides and mixtures thereof.

5. A polymer additive composition as claimed in claim 1 wherein the antiblock agent(s) is selected from inorganic compounds.

6. A polymer additive composition as claimed in claim 1 wherein the components are selected from antioxidants, antistatic agents, stabilizers, flame retardants, metal soaps and nucleating agents.

7. A polymer additive composition as claimed in claim 1 wherein the additive is used at 0.05 to 0.5% by weight of the polymer for manufacturing into polymer films.

8. A polymer additive composition as claimed in claim 1 wherein the polymer is selected from LDPE, LLDPE, PP and EVA.

9. A polymer additive composition as claimed in claim 1 when added to polymer resin is processed into an uniform, transparent film with improved film quality such as optical properties and deposition on equipments when measured by ASTM D-7310 and 1003 as compared to treated or untreated silica or other antiblocks.

10. A polymer additive composition as claimed in claim 1 when added to polymer resin is processed into an uniform, transparent film with dynamic and static coefficient of friction less than 0.3 when measured by ASTM D 1894.

11. A polymer additive composition as claimed in claim 1 when added to polymer resin is processed into an uniform, transparent film with dynamic and static coefficient of friction less than 0.3 and coefficient of friction is 3 to 5 times lower than treated or untreated silica or other antiblocks when measured by ASTM D 1894.

12. A polymer additive composition as claimed in claim 1 when added to polymer resin is processed into an uniform, transparent film with blocking force of less than 5 gm when measured with 5 kg load @50° C. by ASTM D-3354.

13. A polymer additive composition as claimed in claim 1 when added to polymer resin is processed into an uniform, transparent film with blocking force of less than 5 gm and the blocking force is 4 to 5 times lower than treated or untreated silica or other antiblocks when measured with 5 kg load @50° C. by ASTM D-3354.

14. A process for the preparation of polymer additive composition as claimed in claim 1 comprising melting slip agent(s), adding antiblock agent, encapsulating and powdering to obtain a free flowing powder using a spray tower.
